(19) United States
(12) Patent Application Publication
(10) Pub. No.: US 2024/0351237 A1
(43) Pub. Date: Oct. 24, 2024

(54) INDIVIDUALIZATION OF ITEMS OF SELF-BUILD FURNITURE

(71) Applicant: Gerhard BRODNIK, Wien (AT)

(72) Inventor: Gerhard BRODNIK, Wien (AT)

(21) Appl. No.: 18/685,727

(22) PCT Filed: Jun. 15, 2022
(86) PCT No.: PCT/AT2022/060200

§ 371 Date: Feb. 22, 2024

(30) Foreign Application Priority Data
Aug. 24, 2021 (AT) A50685/2021

(51) Int. Cl. B27D 5/00

(52) U.S. Cl. CPC B27D 5/003; B27D 5/006

(57) ABSTRACT

A method for adaptation of dimensions of lightweight furniture panels having an internal honeycomb structure includes the steps of severing an edge strip of the panel with the structurally stable edge zone necessary for stability of the panel; cutting off the honeycomb structure flat in each case along the inner surfaces of the two outer panels; clearing out the honeycomb structure, which has been loosened by the flat cutting-off action, between the two outer panels; supplying a structurally stable replacement strip board; coating the two inner surfaces of the coating panels of the lightweight panel and/or the two outer surfaces of the structurally stable replacement strip board; pressing together the components; severing a residual strip exceeding the intended size of the processed panel from the size-adapted lightweight panel.

### CROSS REFERENCES

This application is a U.S. National Stage Application of International Application No. PCT/AT2022/060200, filed on Jun. 15, 2022, which claims priority to Austrian Application No. A50685/2021, filed on Aug. 24, 2021, the disclosures of each of which are hereby incorporated herein by reference in their entireties.

### TECHNICAL FIELD

The present disclosure relates to production of components furniture and installation structures and, more particularly, to a method for modifying industrially produced lightweight panels for furniture having inner lightweight structures, in particular honeycomb structures, between two outer layers.

### BACKGROUND

Many manufacturers do not use solid particle board, or similar materials, for load-bearing parts of furniture, in particular do-it-yourself furniture, but instead, replace a portion thereof, in particular the core, with a paper honeycomb structure.

If load-bearing parts are sawn off, in order to modify the size of the piece, e.g., to make a piece of furniture smaller, the overall structure is weakened, and load-bearing parts e.g., near the edges of the panel, can no longer fulfill their purpose.

This is a familiar problem, and the following proposals have already been made for solving it:

EP 1 997 597 A2 discloses a device and a method with which the edges of a composite panel are coated with an adhesive. For this, the outer layers are cut with a tool, and the inner honeycomb structure is compressed in order to make space for an edge reinforcement, after which the new edge is coated with an adhesive.

DE 102017106922 A1 discloses adhesive elements for gluing a reinforcement element to a lightweight panel, and a method for doing so. These adhesive elements can only be placed at predefined spacings to one another, in recesses formed in the panel where the middle layer is formed by a honeycomb structure, and then glued in place, such that edge reinforcements can only be placed at specific spacings, between which there are only thin, non-load-bearing, cover panels, connected to one another by the honeycomb structure.

DE 202010016369 discloses something similar.

EP 0584041 discloses a molding strip that is secured to a panel with a corrugated cardboard structure by barbed tabs. This can only be used on the edge of a piece of furniture, and does not reinforce, such that it does not solve the problem addressed by the present disclosure.

DE 1020080200976 A1 relates to a method for producing a lightweight panel for furniture. This lightweight panel is composed of at least one outer layer, and a middle layer with a honeycomb structure that is bonded thereto with an adhesive.

There is a forum at https://www.energiesparhaus.at/forum-ikea-pax-qekuerzt-rueckwand-wie-montieren/49335 in which the question of how the back surface of a Pax box that has been shortened can be attached in a robust manner was raised, because the honeycomb structure that is exposed by the shortening no longer allows for this. In the entry from “me_on_the_road” on May 31, 2018, it was proposed to push in the honeycomb structure where the back surface is to be attached, and glue small blocks of wood between the outer layers there.

A similar method is disclosed in the document from Ikea: Shorten Pax Box, incl. Doors (mydealz) Mar. 29, 2020, https://www.mydealz.de/3iscussion/ikea-pax-schrank-inkl-turen-kurzen-1557513. It is recommended therein to saw off the side walls with a circular handsaw, remove a few centimeters of the honeycomb structure, and glue in a wood strip that has been cut to size, using construction adhesive. The characterizing part of claim 1 is not disclosed therein, because not all of the steps and methods therein are used, and they differ in part with the methods used in the above documents.

### SUMMARY

The present disclosure relates to a particularly simple method for eliminating these weak points more effectively that in the prior art, such that the load-bearing, fully reinforced parts can still fulfill their purposes. The important thing here is that this method can be carried out by practically any reasonably skilled amateur without special tools or machines.

The novel method developed in the framework of this present disclosure for modifying the sizes of commercially available stock lightweight construction panels with which any customer can modify do-it-yourself furniture on an individual basis, is an extremely simple and effective method for modifying furniture of this type to individual specifications.

This enables a customer, usually an amateur, to reduce the depth of a cabinet from an established do-it-yourself furniture manufacturer, without weakening the modified cabinet in any way. The same applies to reducing the width or height of the lightweight panels for do-it-yourself furniture from the same or any other manufacturer.

The subject matter of the present disclosure is a method of the above type, embodiments of which may be characterized by the following sequence of steps:
Step 1: removal of an edge strip on the lightweight panel, in particular with a saw, preferably with a cut parallel to the side of the panel, such that the remaining part of the panel that is to be used is at least 5 mm larger than the desired, final size, cut to fit a specific space, in which the cut is made through the honeycomb structure forming the core of the lightweight panel.
Step 2: separating the honeycomb structure from the outer layers along the inner surfaces thereof to an appropriate depth to ensure that the modified lightweight panel remains robust.
Step 3: removing the part of the honeycomb structure that has been separated from the outer layers.
Step 4: providing a replacement board made of sturdy wood or fibers, in particular wood fibers or particles, which is wider than the space formed by the removal of the honeycomb material, with a material thickness that fits the space between the inner surfaces of the two outer layers of the lightweight panel, or preparing a sturdy replacement board of the right thickness by gluing two stock boards together, which may be of different thicknesses.
Step 5: coating the two inner surfaces of the outer layers of the lightweight panel and/or the outer surfaces of the sturdy replacement board made of wood or fibers, in particular wood fibers or particles, with an adhesive, in particular glue, and inserting the sturdy replacement board into the space formed by the removal of the honeycomb material in step 3 to a depth b13 between the two outer layers of the lightweight panel.
Step 6: clamping the region of the lightweight panel that has been roughly cut to size, into which the sturdy replacement board has been placed over the course of steps 1 to 5.
Step 7: removing the excess part of the panel, at least 5 mm, from the lightweight panel obtained in steps 1 to 6, to obtain a lightweight panel that is cut to size, which is just as sturdy on the side that has been modified, due to the replacement board, as the other sides of the panel.

More particularly, embodiments of the method may include the following steps:
Step 1: the side wall of a cabinet is cut to the necessary size, plus a surplus of at least 5 mm.
Step 2: the honeycomb structure is cut away from the inner surfaces of the outer layers, e.g., fiberboard layers, to a depth corresponding to the width of the replacement board that is to be placed therein.
Step 3: “surgical removal” of the honeycomb structure to a depth corresponding to at least the width of the replacement board that is to be placed therein.
Step 4: providing or preparing a sturdy replacement board that fits into the space between the inner surfaces of the outer panels and inserting it into this space. By way of example, the space between the two fiberboard outer panels, coated with a decorative film, or similar structures, is 13 mm.

There are no standard boards with a thickness of 13 mm, however. Instead, two boards are glued and clamped together, which have a combined thickness of 13 mm, e.g., a particle board with a thickness of 8 mm, and a fiberboard with a thickness of 5 mm. This part is then cut to about 5 mm wider than is ultimately needed for the end product.

Any combination of boards, e.g., particle boards, fiberboards, and/or similar products, with which the necessary thickness can be obtained, can be used to ensure that the lightweight panel remains sturdy after removing the solid edge from the original panel in the subsequent steps.
Step 5: the two inner surfaces of the outer panels, from which the honeycomb structure has been removed to a depth of b13, are coated with an adhesive, and/or the replacement board (composite strip) is coated on both sides with an adhesive. This board is inserted into the empty space formed in the modified lightweight panel, until the part that has been inserted is as wide as the original, load-bearing edge board after cutting the lightweight panel to its final size.
Step 6: the edge of the lightweight panel containing the sturdy replacement board, which is composed of two boards laminated together, and still “too wide,” placed in the space from which the honeycomb material has been removed, is then clamped together.
Step 7: after the adhesive has hardened in the modified lightweight panel where the replacement board has been inserted, the panel is cut to the desired size, and the strip that has been cut off, comprising a narrow strip of the two outer layers and the replacement board glued thereto, is discarded.

The initially removed, structurally sound, load-bearing part of the original lightweight panel, and a part of the original honeycomb structure is replaced in this manner by a new, sturdy component, and can then be glued, screwed, or otherwise joined to the other parts of the piece of furniture, as desired by the customer, or as necessary.

This ensures that the customer can still make minor changes, i.e., placing shelves at different heights, or at arbitrary spacings, without weakening the overall structure of the do-it-yourself furniture.

With the systems from the prior art, the shelves will not support heavy objects, because the reinforcements, which are only placed at specific spacings, are not intended as load-bearing structures. There are “weak points” beneath each of these reinforcements. Because the reinforcement is continuous in the system obtained with the present disclosure, the modified part is much more capable of bearing loads.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 shows the cutting of a lightweight panel in an embodiment of the present disclosure.

FIG. 2 shows the separation of a honeycomb structure from outer panels of a lightweight panel in an embodiment of the present disclosure.

FIG. 3 shows the removal of a honeycomb structure from a core of a lightweight panel in an embodiment of the present disclosure (step 3).

FIG. 4 shows the preparation of a replacement board to be placed in a core of a lightweight panel in an embodiment of the present disclosure.

FIG. 5 shows the coating of inner surfaces of outer layers of a lightweight panel with an adhesive in an embodiment of the present disclosure.

FIG. 6 shows the coating of outer surface of a replacement board with an adhesive in an embodiment of the present disclosure.

FIG. 7 shows a lightweight panel with a replacement board placed therein.

FIG. 8 shows the removal of excess material from a replacement board to obtain the desired size thereof, corresponding to the actual spatial requirements in an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

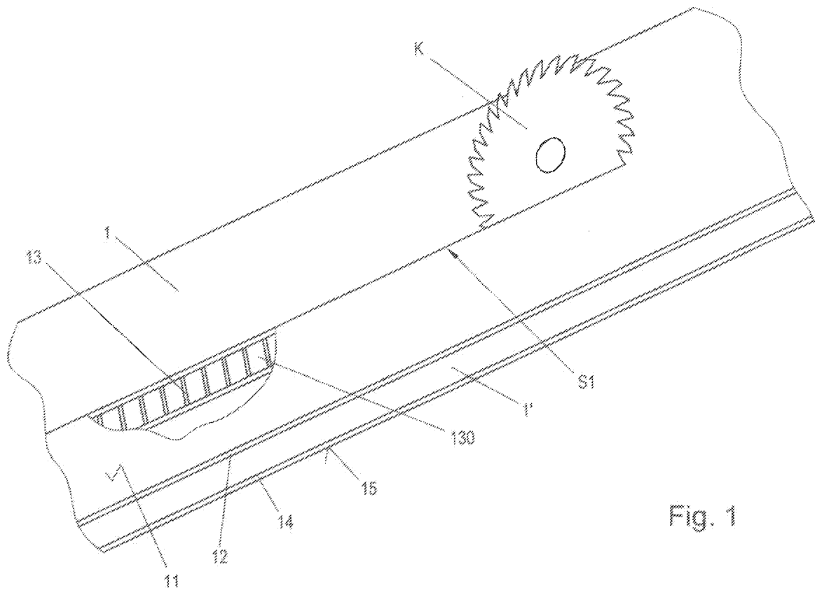

FIG. 1 shows the lightweight panel 1 with the upper and lower outer layers 12, 14, each of which has a decorative coating, in which the inner space 130 between the layers 12, 14 is filled with a honeycomb structure 13. The edge l′ of the lightweight panel 1, reinforced with a sturdy board or the like, is removed with a circular saw K in step S1.

FIG. 2 shows how the honeycomb structure 12 in the core 130 of the lightweight panel 1 is cut out with a tool M along the inner surfaces 120, 140 of the outer layers 12, 14 that have the film coatings 11, 15.

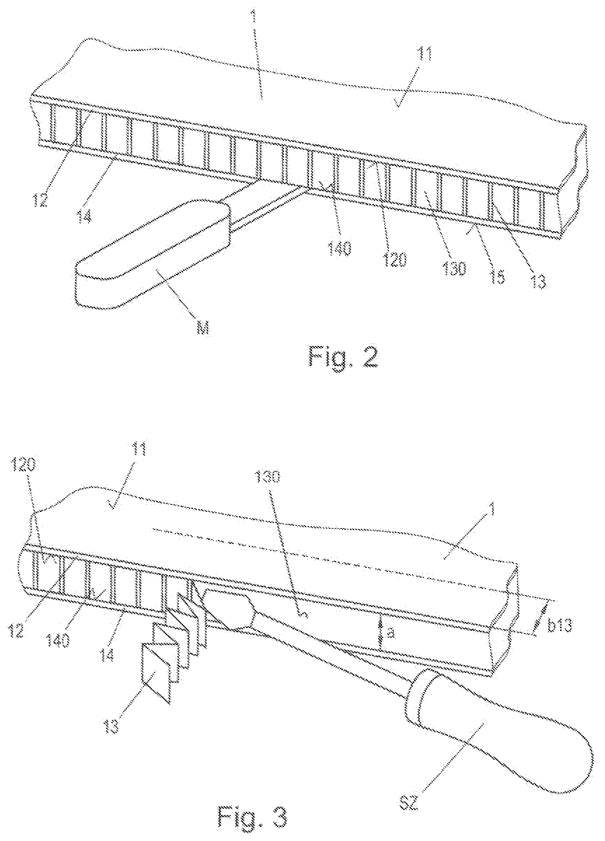

FIG. 3 shows how the honeycomb structure 13 is removed from the core 130 of the lightweight panel 1, in this case using a screwdriver SZ.

The width b13 of the now “empty” portion of the edge of the lightweight panel 1, and the spacing a between the inner surfaces 120, 140 of the outer layers 12, 14, which basically corresponds to the width b10 of the replacement strip 10 made of a sturdy material that is to be inserted therein.

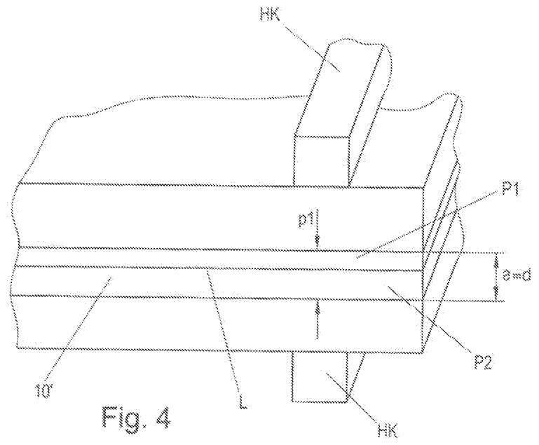

FIG. 4 shows the clamping of the two sturdy boards P1, P2 of different thicknesses that are to be bonded together by an adhesive L to obtain the replacement board 10′ with a thickness d corresponding to the space a between the outer layers 12 and 14, using clamps HK.

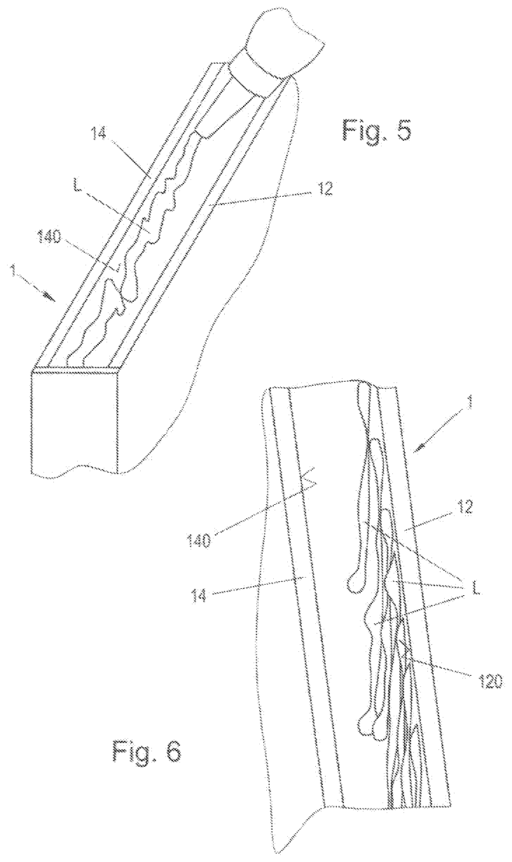

FIGS. 5 and 6 show the coating of the inner surfaces 120, 140 of the outer layers 12, 14 with adhesive L.

The replacement board 10, which can also be coated on both sides with adhesive L, is inserted between the outer layers 12, 14.

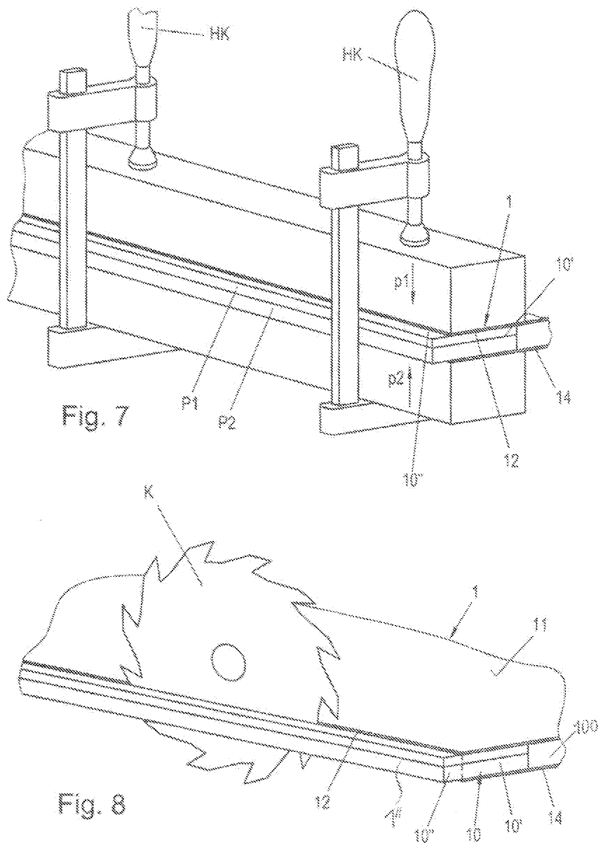

FIG. 7 shows the clamping of the edge of the lightweight panel 1 that is to be reinforced, or is now reinforced, from which only an edge 10″ of the original replacement board 10′ still protrudes, which will ultimately be discarded.

Lastly, FIG. 8 shows the removal of the edge 10″ along with the, e.g., 5 mm width of the rest of the edge of the lightweight panel 1, which is still too wide by these 5 mm, for example.

This results in a lightweight panel 1 that is cut to size, while retaining its sturdiness.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A method for modifying lightweight panels for furniture or installation structures having internal lightweight structures, in particular honeycomb structures, between two outer, layers to which lightweight structures are bonded with an adhesive and surrounded on each sides by a frame comprising the steps of:
cutting an edge strip from a lightweight panel to provide the lightweight panel with a panel dimension larger than a corresponding final dimension, wherein the cut is made through the honeycomb structure;
separating a part of the honeycomb structure from the two outer layers along inner surfaces of the two outer layers to desired depth;
removing the part of the honeycomb structure that has been separated from the outer layers removal of the part of the honeycomb structure forming a space between the inner surfaces of the two outer layers;
providing a replacement board made of wood wherein the replacement board is wider than the space between the inner surfaces of the two outer layers and has a thickness approximately equal to the space between the inner surfaces of the two outer layers,
coating at least one of the inner surfaces of the outer layers and outer surfaces of the replacement board with an adhesive and inserting the replacement board into the space between the inner surfaces of the two outer layers;
clamping at least a region of the lightweight panel corresponding to where the replacement board has been inserted into the space between the inner surfaces of the two outer lavers; and
cutting the lightweight panel to the corresponding final dimension.

2. The method according to claim 1, wherein the replacement board comprises at least one of natural wood, particle board, fiberboard.

3. The method according to claim 1, wherein the replacement board comprises two materials adhered together, each of the two materials comprising one of natural wood, particle board, or fiberboard.

4. The method according to claim 1, wherein the step of cutting an edge strip from the lightweight panel further comprises cutting parallel to a side of the lightweight panel.

5. The method according to claim 1, wherein the panel dimension is at least 5 mm larger than the corresponding final dimension.

6. The method according to claim 1, wherein the replacement board comprises at least one of wood fibers and wood particles.

7. The method according to claim 1, wherein the step of providing a replacement board comprises adhering two stock boards of different thicknesses together.
